(19) United States
(12) Patent Application Publication
(10) Pub. No.: US 2012/0084226 A1
(43) Pub. Date: Apr. 5, 2012

(54) MEASURING OR ESTIMATING USER CREDIBILITY

(75) Inventors: Vanessa Murdock, Barcelona (ES); Roelof van Zwol, Sunnyvale, CA (US); Emmanouil Papangelis, Toronto (CA)

(73) Assignee: Yahoo! Inc., Sunnyvale, CA (US)

(21) Appl. No.: 12/898,644

(22) Filed: Oct. 5, 2010

(51) Int. Cl. G06F 15/16; G06F 3/01; G06Q 99/00

(52) U.S. Cl. 705/347; 715/753

(57) ABSTRACT

A method or system for measuring or estimating user credibility is described.

### CROSS-REFERENCE TO RELATED APPLICATIONS

The present application is related to concurrently filed U.S. patent application Ser. No. ______ (attorney docket no. 070.P113), titled “Media or Content Tagging Determined by User Credibility Signals,” by Murdock et al., and to concurrently filed U.S. patent application Ser. No. ______ (attorney docket no. 070.P124), titled “User Credibility in Electronic Media Advertising,” by Van Zwol et al., both of which are incorporated herein by reference in their entirety, and assigned to the assignee of the presently claimed subject matter.

### BACKGROUND

1. Field

The subject matter disclosed herein relates generally to measuring or estimating user credibility.

2. Information

Electronic information in the form of electrical signals, for example, continues to be generated or otherwise identified, collected, stored, shared, or analyzed. Databases or other like repositories are commonplace, as are related communication networks or computing resources that provide access to stored signal information. As one example, the World Wide Web provided by the Internet continues to grow with seemingly continual addition of information.

Computing resources enable users to access a wide variety of signal information in the form of media or content, including text documents, images, video, or audio, to name just a few examples. Tools or services have been provided which allow for access to or organization of copious amounts of signal information. For example, some tools may enable users to associate supplemental signal information with media or content to indicate or describe a characteristic of the media or content. As one example, users may associate keywords (e.g., tags) or geographic locations (e.g., latitude and longitude coordinates) with media or content that are descriptive of a particular target geographic location. Supplemental information, for example, may be used to enable more searching or classifying of media or content by search engines or human users. However, with large amounts of signal information being made available, there is a continuing need for relevant information to be identified and presented in an effective manner.

### BRIEF DESCRIPTION OF DRAWINGS

Claimed subject matter is particularly pointed out and distinctly claimed in the concluding portion of the specification. However, both as to organization or method of operation, together with objects, features, or advantages thereof, it may be better understood by reference to the following detailed description if read with the accompanying drawings in which:

FIG. 1 is a schematic block diagram of an example computing environment according to one implementation.

FIG. 2 is a flow diagram illustrating an example process for measuring or estimating user credibility according to one implementation.

FIG. 3 is a flow diagram illustrating an example process for updating user credibility signal sample values according to one implementation.

FIG. 4 is a flow diagram illustrating an example process for employing user credibility signal sample values to present or provide content to a special purpose computing system.

FIG. 5 depicts a table of example user credibility signal sample values.

FIGS. 6-8 depict tables of user information obtained from an example of a communications network.

FIGS. 9-16(b) depict graphs showing application of a shuffle test to a communications network.

FIG. 17 depicts an example of a process for measuring or estimating potential social influence according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description are presented in terms of algorithms or symbolic representations of operations on binary digital signals stored within a memory of a specific apparatus or special purpose computing device or platform. In the context of this particular disclosure, the term specific apparatus, special purpose computing device, or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It is further recognized that all or part of the various devices or networks described herein, or the processes, methods, or operations as further described herein, may be implemented using or otherwise include hardware, firmware, software, or any combination thereof, although to be clear, this is not intended to refer to software per se, which may constitute an abstract idea.

It has proven convenient at times, principally for reasons of common usage, to refer to signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the disclosed subject matter, it will be appreciated that throughout this specification discussions utilizing terms such as “processing,” “computing,” “calculating,” “determining”, “performing”, “identifying”, “obtaining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Implementations relating to methods, apparatuses, or systems are disclosed for measuring or estimating user credibility of one or more users in a variety of contexts, such as, for example, in connection with a communications network or other circumstances in which media or content may be communicated or otherwise transmitted or exchanged. In this context, a communications network may comprise an electronic social network. An electronic social network may refer to a communications network or web-based social grouping of individuals, such as, for example, an on-line virtual community who may share interests, ideas, activities, opinions, events, etc. by posting or otherwise communicating content via a communications network, such as the Internet (e.g., on on-line bulletin boards, discussion forums, blogs, profile homepages, etc.), wherein individual members of the group may be represented by nodes, and relationships between members may be represented by associational links or ties, for example. Likewise, estimates of user credibility may be applied or employed, for example, for more effective selection of useful or relevant signal information or content.

A communication or electronic social network may be centered around one or more characteristics of one or more electronic media or content items, such as with a photo sharing platform, such as Flickr, as an example. User's of a photo sharing platform may, for example, upload or share photos with other users, comment on or tag their own photos or the photos of other users, establish links between themselves and other users, or join user groups. Measuring or estimating user credibility in an electronic communication or social network may therefore provide a measure or estimate of accuracy or reliability attributed, at least in part, to a user in performing a particular activity or evaluating a particular characteristic with respect to electronic media or content items, such as, for example, geotagging of images.

User credibility may indicate a user's reputation with respect to the user's accuracy in engaging in a particular activity or evaluating a characteristic of electronic media or content items. However, it may be useful to determine whether or to what degree credibility of a user may potentially be correlated to social influence. In geotagging implementations, for example, social influence may be said to exist if a user's action to begin geotagging is influenced by one or more others having also utilized geotagging. Contrary to what one might expect, we conclude based on empirical evaluation that credibility of a user does not appear to be significantly correlated with social influence. This conclusion and supporting empirical analysis, including figures, is provided in more detail beginning at paragraph 55. Therefore, contrary to conventional wisdom, measuring or estimating user credibility may be accomplished largely independent of social influence. This useful and beneficial result leads to a convenient and tractable approach to estimating or measuring user credibility that might otherwise be overlooked.

As one example situation, without limitation, supplemental signal information, for example, intended to be descriptive of electronic content, such as a characteristic thereof, for example, may be suggested to a user for association with an electronic media or content item in at least one implementation by filtering a domain of supplemental information associated with electronic media or content items. Filtering of supplemental information, for example, may be based, at least in part, on user credibility signal sample values that estimate a user's accuracy in associating media or content items with supplemental information, including, for example, tags, user ratings, geographic locations, or other descriptive electronic information. User credibility signal sample values may be derived cumulatively over multiple associational acts performed by a user, for example. In this way, user credibility signal information may be used to assist in selection of content that may be presented to other users, for example. Content that is favored or otherwise identified by more credible users may be filtered or selected for presentation to a user in at least one implementation.

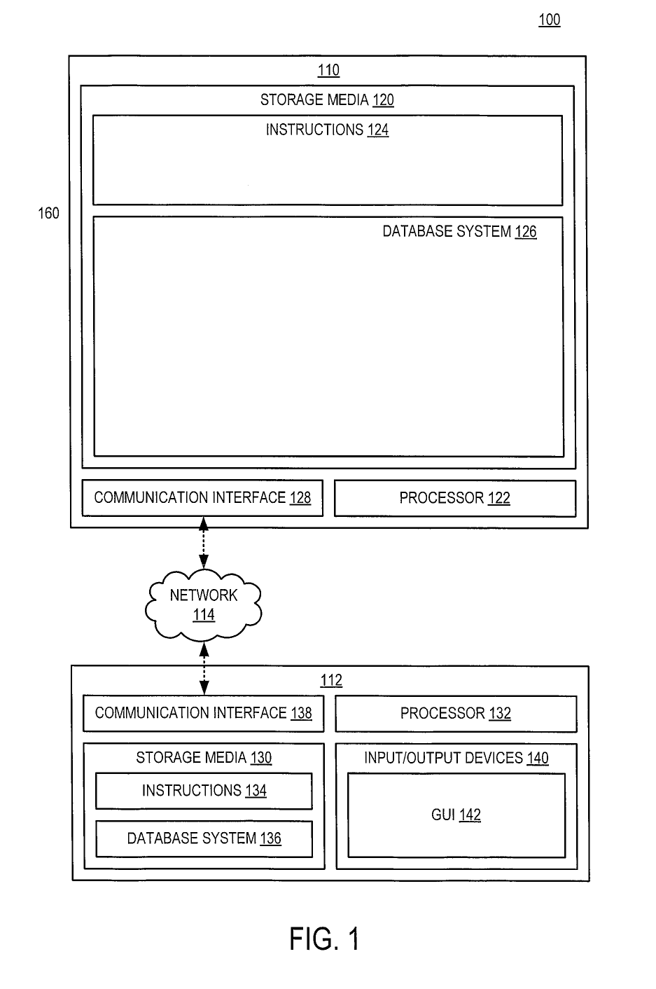

FIG. 1 is a schematic block diagram of an example computing environment 100 according to one implementation. As illustrated by FIG. 1, example computing environment 100 may include special purpose computing devices or systems, such as 110 or 112, for example. Special purpose computing devices or systems, such as 110 or 112, may, for example, comprise a desktop computer, a laptop computer, a handheld computer, a mobile computing device, or other suitable media device(s) that include computing capabilities along with the device(s), such as, for example, a camera device, a telecommunications device, a media player device, a personal digital assistant, etc.

For example and without limitation, device or system 110 may comprise a server system. Likewise, one or more devices or systems, such as 112 may, for example, but without limitation, comprise a network client. Likewise, in at least one embodiment, devices or systems, such as 110 or 112, may communicate via a network 114. For example, and without limitation, network 114 may comprise one or more local area networks, one or more wide area networks, one or more cell phone networks, one or more wire line telephone networks, one or more personal area networks, the Internet or any combination thereof, just to name a few possible examples. Likewise, it is, of course, understood, that an implementation or embodiment is not limited in scope to a particular number of special purpose computing devices. Example computing environment 100 may include one, two, three, tens, hundreds, thousands, millions, or more special purpose computing devices, for example

Accordingly, devices or systems 110 or 112 may also include storage media, such as, for example, 120 or 130, and one or more processors, such as, for example, 122 or 132. Likewise, storage media, such as 120 or 130, for example, may include instructions stored thereon, such as 124 or 134, for example, that may be executable, for example, by one or more processors to perform one or more operations, processes, or methods, including those, for example, described in more detail hereinafter. As one example, instructions 124 or 134 may comprise a web browser application or other suitable program, software, or firmware, etc. to retrieve, load, or process signal information (e.g., electronic documents or the like), such as may be communicated between special purpose computing devices, for example. Devices or systems 110 or 112 may further include a communication interface, such as 128 or 138, for example, to facilitate wired or wireless communication via network 114, for example, by transmitting or receiving signal information.

Systems or devices 110 or 112 may include one or more peripherals, such as, for example, one or more input devices or output devices. Non-limiting examples of input devices include a keyboard, a touch-screen, a touch-pad, a microphone, a camera, or a pointing device, such as a controller or a mouse, etc. Non-limiting examples of output devices include an audio speaker, a tactile feedback device, a display, a touch-screen, etc. In at least one implementation, devices or systems may also include a graphical user interface (GUI) application or other suitable program, software, or firmware, etc., such as 142. As one example, execution of a GUI 142 may result in display of icons or other small pictographs, such as in the form of bit maps, for example, which may be capable of being viewed via an output device, although this is merely one illustrative example.

Again, implementation or example 100 is provided for purposes of illustration and claimed subject matter is not limited in scope to implementation or example 100. For example, server system 110 may comprise one or more computing platforms such as, for example, one or more network servers. As alluded to previously, server system 110 may include storage media 120 and one or more processors, such as example processor 122. Also alluded to previously, storage media 120 may include instructions 124 stored thereon that may be executable, for example, by one or more processors, such as, for example, processor 122, to perform one or more operations, processes, or methods, including, for example, operations, processes, or methods described in more detail hereinafter. Storage media 120 may further include an electronic repository to store signal information, such as database system 126, for example. Likewise, one or more processors of system 110, such as, for example, processor 122, may be capable of writing signal information to or reading signal information from storage media 120, for example. Likewise, as also alluded to above, server system 110 may further include a communication interface 128 to facilitate wired or wireless communication via network 114, such as transmitting or receiving electronic signal information, for example.

Server system 110 may suggest supplemental information to be associated with one or more electronic media or content items responsive to user signal information received, for example, from network client 112. However, computing environment 100 depicts a non-limiting example of a computing platform for suggesting supplemental information to be associated with media or content. Other suitable computing platforms and network configuration may be utilized where appropriate in other implementations or embodiments.

In at least one implementation, server system 110 may be operated as a stand-alone special purpose computing platform. Server system 110 may further include any suitable user interface for facilitating user interaction with server system 110. Hence, potential implementations or embodiments within the scope of claimed subject matter are not limited to a particular configuration or a particular computing environment.

Referring again to server system 110, database system 126 may include a media or content library comprising a plurality of media or content items, including one or more example media or content items. A media or content item may comprise stored signal information representative of a variety of types of content, including, for example, visual content (e.g., an image, a video, textual content, etc.) or audio content (e.g., a sound recording). Accordingly, a media or content item may comprise binary digital signals, for example, arranged according to any suitable format including, for example, .jpeg, .mpeg, .mp3, .txt, etc., among other formats. A media or content library may comprise any number of media or content items, including tens, thousands, millions, or more media or content items, for example.

Media or content items may be associated by a database system, such as, for example, database system 126, with a variety of supplemental information. For example, a media or content item may be associated with supplemental information. Although claimed subject matter is not limited in scope in this respect, as one example, supplemental information may include: user associated information, target information that may indicate target values (e.g., target geographic locations) for media or content items, or user identifiers that may identify particular users, as explained in more detail below.

In at least one implementation, supplemental signal information may be associated with a media or content item as binary digital signals that may comprise part or a portion of a media or content item itself. In another implementation, supplemental signal information, such as binary digital signals, may be associated with a media or content item using any suitable database system including, for example, relational models, hierarchical models, or network models to name a few examples.

In at least one implementation, supplemental signal information, such as binary digital signals, may be associated with media or content items. Supplemental signal information may, for example, be organized by database system 126. As a non-limiting example, a user may associate supplemental signal information or characteristics, including one or more descriptive tags, one or more geographic locations, user ratings, or other suitable supplemental signal information, with a media or content item. In at least one implementation, for example, a user identifier may indicate a particular user that associated supplemental signal information with the media or content item, as explained in more detail below.

Database system 126 may further include a user database, which may, for example, maintain signal information relating to user interactions with a server system, such as 110, for example. User interactions may include, for example, uploading a media or content item to server system 110 or associating supplemental signal information with a media or content item. For example, user signal information may be representative of signal information relating to individual users, such as comprising user account information or a user identifier, as described above. A user database may include user signal information for any number of users, including tens, thousands, millions, or more users, for example.

In at least one implementation, user signal information may also comprise an associated user credibility indicator attributed, at least in part, to an individual user. In at least one implementation, a user identifier may also enable distinguishing a variety of interactions by multiple users, such as with server system 110, for example. A user identified by a user identifier may have, in an interaction, associated supplemental signal information with a media or content item. In this particular example, a user identifier may indicate that a user has uploaded a media or content item or associated supplemental information with a media or content item. As non-limiting examples, a user identifier may comprise an email address, a user reference number or character string, etc. A user credibility indicator may indicate one or more user credibility signal sample values, as described in more detail below. In at least one implementation, a user identifier may be presented along with an associated user credibility indicator to other users, such as via a communication network. In this way, users may identify a particular user by a user identifier and a credibility signal sample value for the particular user indicated by the user credibility indicator.

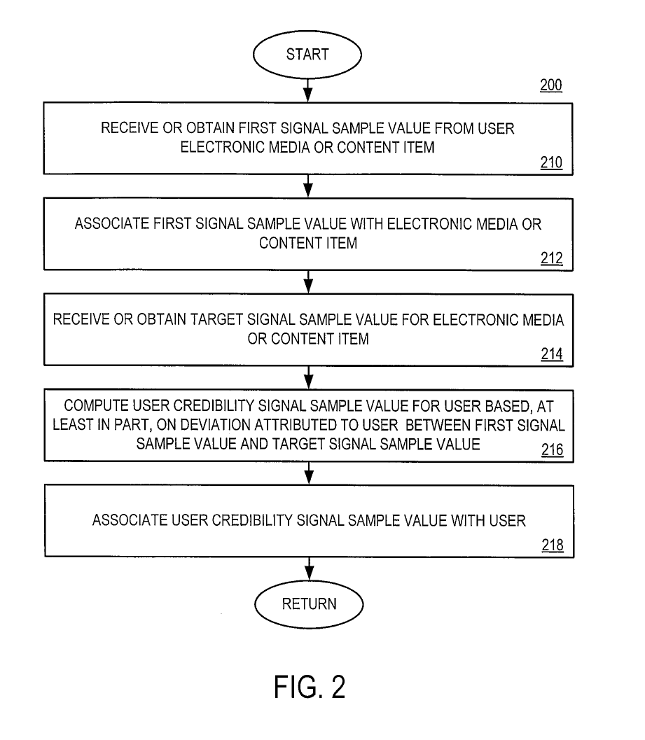

FIG. 2 is a flow diagram illustrating an example process 200 for estimating or measuring user credibility according to one implementation. Of course, claimed subject matter is not limited in scope to this particular implementation, which is provided primarily for purposes of illustration. In another implementation, for example, additional or alternative operations may be employed. Likewise, claimed subject matter is not necessarily limited to the particular order of operations shown in FIG. 2.

Nonetheless, continuing with FIG. 2, in at least one implementation, user credibility may be represented by one or more user credibility signal sample values attributed, at least in part, to a particular user, for example. As described in more detail later, for at least one implementation, user credibility signal sample values determined, at least in part, in accordance with process embodiment 200 may be used in connection with presentation of content to one or more other users, for example.

Beginning at 210, supplemental signal information represented by at least a first signal sample value may be obtained or received from a user to be associated with an electronic media or content item. A particular user may be identified in at least some implementations by a user identifier obtained via a login process, for example. However, other suitable approaches may be used to identify a user providing signal sample values to be associated with electronic media or content.

A first signal sample value obtained or received at 210 may comprise, for example, a text string (e.g., a tag) including one or more text characters indicating an attribute of an electronic media or content item. As a non-limiting example, tags may comprise a text string representative of a keyword or key phrase assigned to an electronic media or content item by a user to indicate a characteristic, such as a context or content of an electronic media or content item, for example. Tags associated with electronic media or content items may be used, for example, by other users in conjunction with browsing, categorizing, or searching electronic media or content items, for example.

As another example, a first signal sample value may comprise other suitable information indicating an attribute of an electronic media or content item, such as a user rating that may be represented by a numerical signal sample value, a select number of stars of a star rating system (e.g., 4 out of 5 stars), a thumbs up or thumbs down value, etc. Supplemental signal information represented by at least a first signal sample value may be obtained or received via a variety of mechanisms, such as a text field or other suitable interface so that a user may associate a signal sample value with a particular electronic media or content item. As one example, a web browser application or other suitable program, software, or firmware, etc. may be employed to receive, retrieve, load, or process signal information (e.g., electronic documents or the like), such as may be communicated between special purpose computing devices, for example. Thus, a special purpose computing system operated by a user may communicate with a server system, such as 110, for example, via a web browser application in which signal information may be entered via the user's special purpose computing system and transmitted to the server system, such as 110. Of course, claimed subject matter is not limited in scope to this example.

At 212, a first signal sample value (e.g., obtained or received at operation 210) may be associated with an electronic media or content item. For example, in the context of computing environment 100 of FIG. 1, server system 110 may associate a first signal sample value with an electronic media or content item. At 214, a target signal sample value for the electronic media or content item may also be obtained or received. For example, a target signal sample value for an electronic media or content item may in at least one implementation be computed based, at least in part, on supplemental information associated with the media or content item or by retrieving a previously computed or assigned target signal sample value for the electronic media or content item. For example, in the context of computing environment 100 of FIG. 1, a target signal sample value may be retrieved from an electronic database system, as an example.

As one example, a first signal sample value received or obtained at operation 210 may comprise a textual tag and a target signal sample value obtained or received at operation 214 may comprise a selection of a set of one or more textual tags describing an attribute of an electronic media or content item. A set of one or more textual tags may be obtained or received from one or more other users associating the set of one or more textual tags with a media or content item. In at least one implementation, a selection of a set of one or more textual tags may comprise textual tags associated with an electronic media or content item by users estimated to be associated with at least a threshold level user credibility signal sample value, for example.

As another example, a particular media or content item, such as an image, may depict a particular unidentified location. A first signal sample value received or obtained at operation 210 may therefore comprise a geographic location provided by a user, such as indicated by longitude and latitude signal sample values, to identify the otherwise unidentified location. For example, in at least one implementation, a target geographic location may be selected from a predetermined set of geographic locations that comprise distinguishable geographic location identifiers. For example, supplemental signal information comprising a first signal sample value may be obtained from a user indicating a geographic location via a graphical representation of a geographic map to be associated with an electronic media or content item. Furthermore, other users may have previously provided geographic locations for the particular unidentified location resulting in a target signal sample value. A target value for an electronic media or content item may therefore be based at least in part on one or more geographic locations associated with the electronic media or content item by one or more other users.

As yet another example, a first signal sample value received at operation 210 may comprise a user rating received from a user for a person, place, or thing (e.g., a product) represented by an electronic media or content item; however, a target signal sample value for the person, place, or thing represented by the electronic media or content item may comprise a weighted or filtered combination of a plurality of user ratings received from at least one or more other users. In at least one implementation, a filtered or weighted combination of user ratings may comprise a statistical mean or average, for example.

At 216, a user credibility signal sample value may be computed based, at least in part, on a deviation attributed to a user between a user-supplied and a target signal sample value. As one non-limiting example, a deviation attributed, at least in part, to a particular user may comprise a distance, such as geodesic distance, between a user associated geographic location and a target value for an electronic media or content item based at least in part on one or more geographic locations associated with the electronic media or content item by one or more other users, for example, in at least one implementation. In another implementation, a target signal sample value may comprise an actual geographic location for a media or content item.

At 218, a user credibility signal sample value may be associated with a user identifier that identifies a user, for example. In at least one implementation, associating a user credibility signal sample value may comprise storing a user credibility signal sample value in association with a user identifier, such as in a database, for example. For example, in the context of computing environment 100 of FIG. 1, a user credibility signal sample value may comprise a user credibility indicator associated with a user identifier. Alternatively or in addition, in an implementation, a special purpose computing system may be identified rather than a user. As will be described in greater detail with reference to FIG. 4, in at least one implementation, a user credibility signal sample value may be used to provide or suggest content to other users.

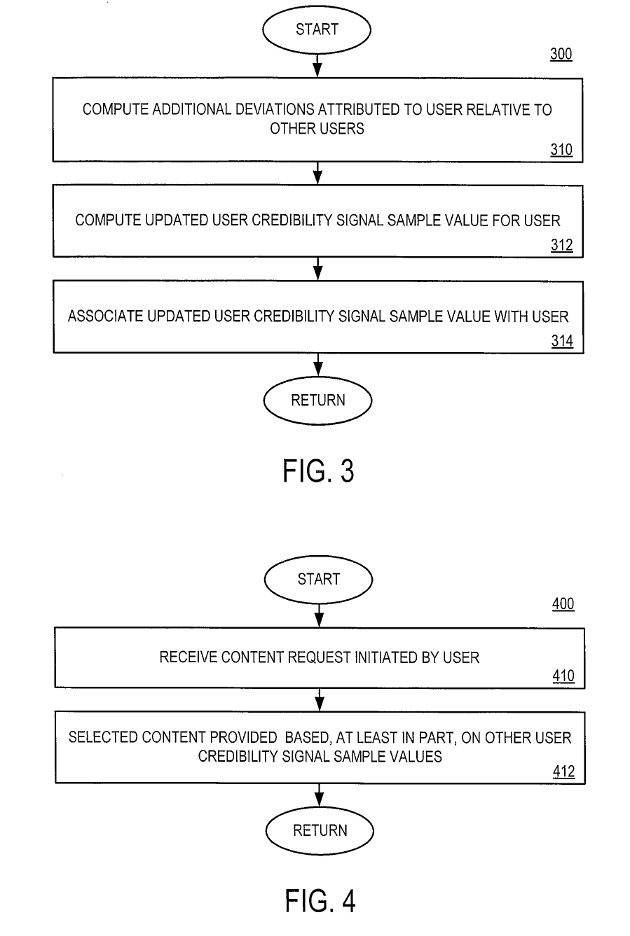

FIG. 3 is a flow diagram illustrating an example process 300 for updating user credibility signal sample values according to one implementation. At 310, additional deviations attributed, at least in part, to a user relative to other users may be computed. As previously described with reference to operation 216, for example, a deviation may be estimated or computed between a signal sample value associated by a user with an electronic media or content item and a corresponding target signal sample value for the electronic media or content item. As indicated previously, as one example, a deviation attributed, at least in part, to a particular user may comprise a distance, such as a geodesic distance, between a user associated geographic location and a target geographic location in at least one implementation. However, as indicated above, in at least one implementation, for example, a target signal sample value for an electronic media or content item may be based at least in part on one or more geographic locations associated with the electronic media or content item by one or more other users, for example. Therefore, as more user signal sample values are obtained or received, a target signal sample value may be updated. Likewise, a user's credibility signal sample value may therefore be updated.

At 312, therefore, an updated user credibility sample value may be computed for a user based, at least in part, on additional deviations in at least one implementation. At 314, an updated user credibility signal sample value may be associated with a user. For example, an updated user credibility signal sample value may be associated with a user identifier of an electronic database system.

FIG. 4 is a flow diagram illustrating an example process 400 for presenting content based at least in part on one or more user credibility signal sample values. At 410, a content request initiated by a user may be received to which a content response may be provided. At 412, content may be provided in response to the request received based, at least in part, on user credibility signal sample values for one or more other users. For example, operation 412 may comprise selecting or identifying content based, at least in part, on one or more user credibility signal sample values. Selected content may be transmitted, such as by server system 110, for example, for presentation to a user. As one example, without limitation, selected examples from a database of art work or sound recordings found appealing to users based at least in part on user credibility signal sample values may be transmitted.

A non-limiting example concrete example is now provided for purposes of illustration. An electronic media or content item (p) of a set (P) comprising one or more electronic media or content items (e.g., expressed asp ∈ P) may be associated with a set of supplemental signal sample information: Tₚ={tₚ₁, tₚ₂, . . . , tₚₖ}, referred to here as tags. A deviation (dᵤwᵢ) attributed, at least in part, to a user may be determined, for example, between a user associated geographic location identified and a target geographic location (wᵢ) in at least one implementation. As a non-limiting example, distance may be determined as a geodesic distance that, at least in part, accounts for or is an estimate of curvature of the earth's surface.

For a target geographic location (wᵢ), location tags associated with other media or content items by other users may be identified. A deviation attributed, at least in part, to a user may be compared to a filtered combination of deviations attributed to other users. For example, a filtered combination of deviations attributed, at least in part, to other users, may be employed to estimate or determine relative accuracy. In at least one implementation, a comparison may be used to identify whether a deviation attributed, at least in part, to a user is within a particular range of a filtered combination of deviations attributed, at least in part, to other users.

In at least one implementation, a comparison may be used or applied for classification. As a non-limiting example, a user's associational activity, such as providing a tag or a geographic location for a media or content item, may be considered a “hit” if a difference between a filtered combination of deviations d̅^̅{̅w̅}̅^̅{̅ᵢ̅}̅ attributed to other users and a deviation attributed to the user dᵤ^{w}^{ᵢ} is larger than λ times a standard deviation σ^{w}^{ᵢ}. For example, let W={w₁, w₂, . . . , wₖ,} be a set of distinct target geographic locations in the set after mapping media or content items to a corresponding target geographic location. Let a random variable “D” represent distances in a users' associational activity from target geographic locations. Assume that for a specific geographic location wᵢ a random variable D takes on N real values d₁^{w}^{ᵢ}, d₂^{w}^{ᵢ}, . . . , d_{N}^{w}^{ᵢ}, with arithmetic mean d̅^̅{̅w̅}̅^̅{̅ᵢ̅}̅ and standard deviation σ^{w}^{ᵢ} of users' sample distances for a target geographic location. Accordingly, a “hit” may be indicated if relationship (1) is satisfied and a “miss” may be indicated if relationship (2) is satisfied.

d̅^̅{̅w̅}̅^̅{̅ᵢ̅}̅−dᵤ^{w}^{ᵢ}>λ·σ^{w}^{ᵢ} (1)

d̅^̅{̅w̅}̅^̅{̅ᵢ̅}̅−dᵤ^{w}^{ᵢ}≦λ·σ^{w}^{ᵢ} (2)

In the above relationships (1) and (2), λ comprises a parameter that at least partially affects selectivity of hits or misses in an associational process. A smaller λ may indicate that a hit is more likely for a user to obtain because a larger deviation from a target geographic location may be tolerated. Relationships (1) and (2) are non-limiting examples for distinguishing hits and misses by a user. One or more of these processes may be performed for other location tags associated with media or content items by a user to obtain a set of deviations attributed, at least in part, to that user over multiple associational interactions. A user credibility signal sample value for a user may therefore be determined based at least in part on comparisons performed for one or more location tags of the same or a similar location category that were associated with media or content items by a user.

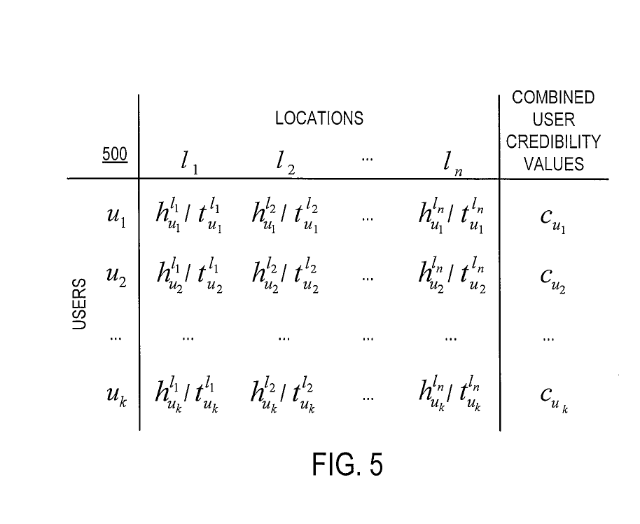

Referring to FIG. 5, a table 500 of user credibility sample values is depicted for an example set. As shown in table 500, let U={u₁, u₂, . . . , uₖ} be a set of k users, and let L={l₁, l₂, . . . , lₙ} be a set of n location categories. Credibility of a user u ∈ U for a specific location category lᵢ may be defined as the number of hits hᵤ^{l}^{ᵢ} of a given location category, divided by a total number of associated media or content items of that location category tᵤ^{l}^{ᵢ}. Where a user credibility signal sample value is determined for a user for two or more location categories, the two or more user credibility signal sample values may comprise a user credibility vector attributed, at least in part, to the user. As further shown in table 500 of FIG. 5, a user may be attributed with a combined user credibility signal sample value (cᵤ) in at least one implementation that comprises a combination of two or more user credibility signal sample values of two or more associational categories. A combined user credibility signal sample value may comprise a sum, a product, or other combination of two or more user credibility sample values of a user. Referring to FIG. 5, mentioned previously, a table 500 of user credibility sample values is depicted for an example set, as previously described. As shown in table 500, let U={u₁, u₂, . . . , uₖ} be a set of k users, and let L={l₁, l₂, . . . , lₙ} be a set of n location categories. Credibility of a user u ∈ U for a specific location category lᵢ may be defined as the number of hits hᵤ^{l}^{ᵢ} of a given location category, divided by a total number of associated media or content items of that location category tᵤ^{l}^{ᵢ}. Where a user credibility signal sample value is determined for a user for two or more location categories, the two or more user credibility signal sample values may comprise a user credibility vector attributed, at least in part, to the user. Alternately or in addition, a user may be attributed, at least in part, with a combined user credibility sample value (cᵤ) in at least one implementation that comprises a combination of two or more user credibility signal sample values of two or more location categories. For example, referring to table 500 of FIG. 5, if subscripts 1, 2, . . . k of cᵤ, denote location categories, a combined user credibility signal sample value may comprise a filtered combination of two or more user credibility sample values, such as an average or other combination.

As discussed previously, claimed subject matter, such as, for example, embodiments described above, measure or estimate user credibility by treating user credibility as largely independent of social influence. Although a convenient assumption, supplying empirical evidence to support this conclusion demonstrates the utility of subject matter, such as the embodiments previously described, for example.

In at least some communication or electronic social networks, such as Flickr, for example, a user may be notified if other linked or connected users perform certain actions such as, for example, geotagging a media or content item. In this example, social influence may be defined to exist if a first user has a social connection in a social network with at least one other user that has previously performed certain actions before the first user. In this example, it is noted that operations or activities of users may be at least partially visible, if not fully visible, to other users of the particular electronic social network, such as Flickr, in this example. In this example, we refer to performing certain visible actions as activation and refer to users as nodes of a network. In one example, a method to determine if activation of a node may be attributed to social influence may comprise evaluating whether activation of one or more nodes over a monitoring period [0,T] occurs randomly or is instead influenced by earlier activation of neighboring nodes in the social network. If the latter condition exists, then it may be assumed that some social influence exists in the social system, and therefore nodes that have one or more already active neighboring nodes may be considered to have a higher probability of being activated than nodes not already having one or more active neighboring nodes. Here, a time of activation of nodes may identify potential social influence. Note that one departure from other types of social networks that have been studied may comprise at least partial visibility of operations or activities as described above.

For example, let A={v₁, v₂, . . . , vₖ} comprise a set of k users that are activated during a period [0,T] and assume that user Vi is activated at time tᵢ. Since activations are considered to occur in discrete time, an ordering of k activation times may be identified. To determine whether social influence exists in a social network, a shuffle test may be performed, which may comprise, for example, the following two operations.

Operation 1 (Original): Performing certain actions (e.g., geotagging) by one or more users may be observed in a social network in a period [0,T]. For node activation it may be determined whether the activation may be attributed to social influence, for example, according to the above described definition of social influence (e.g., at least one neighboring node is already active before activation of the node). Let A_{SI} [symbol] A denote a set of node activations that may be attributed to social influence. The effect of social influence SI_{original} may be identified from the relationship:

$${SI}_{original} = \frac{{A}_{SI}}{A}$$

Operation 2 (Shuffled): Next a second instance may be created with the same or substantially the same graph G and the same or substantially the same set A of active nodes as described above, for example, by selecting a random or other suitable permutation π of {1, 2, . . . , k} and setting the time of activation of node vᵢ to t′ᵢ:=t_{π(i)}. Again, activation may be observed in the period [0,T] as in Operation 1 above, and a new set A′_{SI} [symbol] A of activations may be determined that may be attributed to social influence. The effect of social influence SI_{shuffled} may be determined from the following relationship:

$${SI}_{shuffled} = \frac{{A}_{SI}^{′}}{A}$$

If SI_{original}>SI_{shuffled} then it may be concluded, in at least some examples, that some level of social influence may be present. The effect of social influence may be monitored at any specific time t ∈ [0,T] (or if a specific number of activations has occurred) by comparing, for example, a number of activations that are due to social influence as opposed to random activations by the following relationship:

SI_{t∈[0,T]}^{t}=SI_{original}^{t}−SI_{shuffled}^{t}

The above relation suggests that a timing of activations is not independent of but rather is affected by the number of already activated neighboring nodes. Suitable variations of this shuffle test may be used to distinguish social influence from random adoption. In an electronic social network, activation of nodes may be based on actual observations. The shuffle test may therefore potentially be applied to quantify social influence.

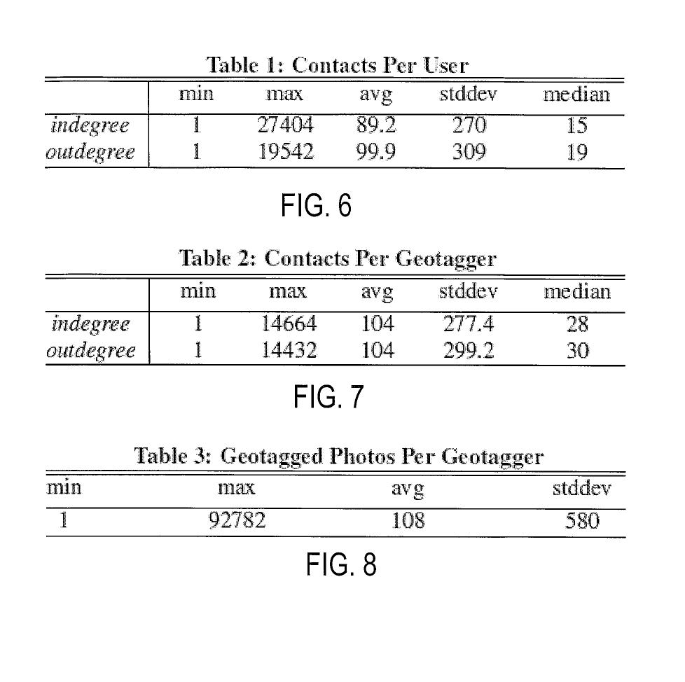

As an example of assessing social influence based at least in part on application of a shuffle test, an electronic social network hosting billions of photos was processed with respect to adoption of geotagging photos. To increase likelihood that users included a large number of users that adopted geotagging, a seed set of 100 active geotagging users of the social network, their contacts, and their contacts' contacts were included. The final set included 525,000 users represented, for example, by respective nodes and 47 million directed edges representing social connections between nodes. From these users, 120,000 users were identified to have used geotagging at least once, termed here geotaggers. FIG. 6 provides descriptive information about network structure for users in the set and FIG. 7 for geotaggers. Moreover, FIG. 8 provides information about the distribution of photos in the electronic social network per geotagger. The example set comprises approximately 13 million geotagged photos.

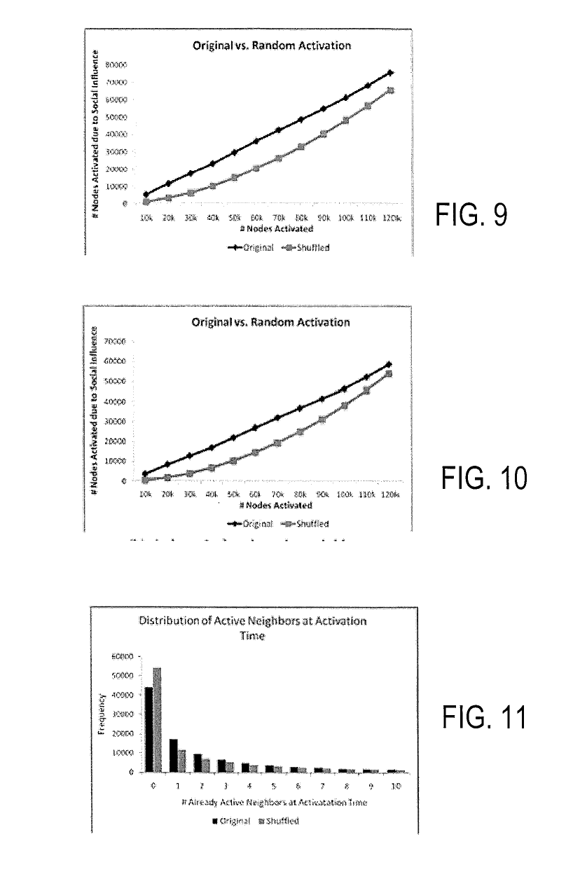

The shuffle test was performed on the set to observe diffusion of geotagging (e.g., node activations) for original and shuffled timestamps provided respectively by operation 1 and operation 2 discussed previously. FIG. 9 shows that for a fixed number of activations, the number of nodes activated at a given timestamp is larger in the original timestamps than the shuffled timestamps. Therefore, adoption of geotagging may be attributed to social influence of users in this particular example.

In the above example, the definition of an activation of a node as a result of social influence has been constrained to having at least one active neighbor at the time of activation. This definition of social influence may be varied by restricting the definition of social influence to having two or more active neighbors at the time of activation. FIG. 10 shows the results of the shuffle test performed with this more restrictive definition where at least two neighboring nodes are already active at the time of activation of a given node. This more restricted definition results, in this particular example, in a smaller percentage of activations attributed to social influence (almost 60,000 in 120,000 as opposed to 78,000 in 120,000 in the previous case).

FIG. 11 shows the distribution of the number of already active nodes at the time that a node is activated for both original and shuffled timestamps. Note that in the case of shuffled timestamps the number of nodes that have no other active neighbor at the time of activation (the initiators) is larger than that of the original timestamps. Hence, initiators are distributed more uniformly in the graph of FIG. 11 in the case of the shuffled timestamps than in the original timestamps. This provides an indication that activations are not random. Moreover, for subsequent definitions (e.g., at least 1, at least 2, at least 3, . . . , at least 10 active nodes at the time of activation) the number of active neighbors is larger in the case of the original than in the shuffled scenario. Therefore, even for more restricted definitions of social influence, there exist activations that may be attributed to social influence as opposed to random activations.

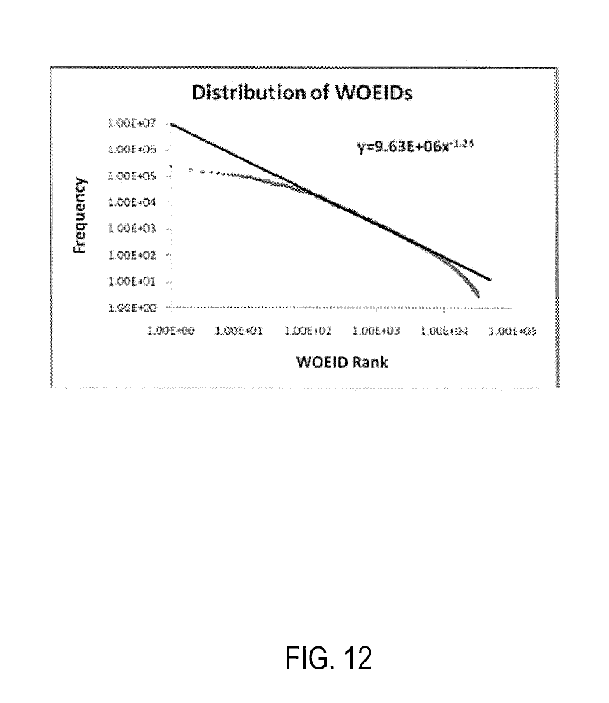

In another example, this system was examined to determine whether more credible users are also more influential users as indicated by social influence. Different users may be more or less accurate at performing a particular activity such as geotagging. Such users may also be more or less accurate at different types of geotagging, such as geotagging at different location types or levels. For example, some users may be highly accurate at identifying points of interest (e.g., monuments, landmarks, etc.), while other users may be highly accurate at identifying locations at a city level or a town level. Still other users may be less accurate and hence less reliable to identify some locations, except, for example, at a country level. Accordingly, a user's credibility may comprise a credibility vector. FIG. 12 plots on a log-log scale the distribution of geographic location identifiers representing a number of times a given geographic location identifier has been identified as a target location.

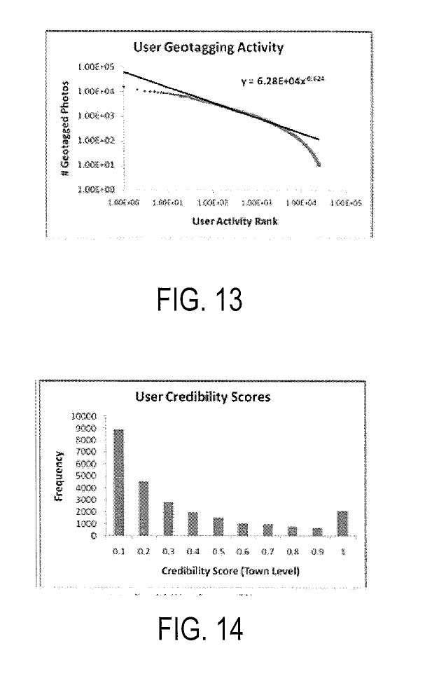

FIG. 13 plots in a log-log scale the distribution of user geotagging activity for the set. The distribution may be modeled quite accurately, for example, by a power law, and the probability f(x) of a user to have geotagged x number of photos is proportional, in this example, to x^{-0.624}. The x-axis represents the rank of a user, taking values from 1 to approximately 25,000, if users are ordered by their activity from the most to the least active users. FIG. 14 shows a histogram of credibility scores for λ=0.75. As previously described, A may comprise a parameter that affects selectivity of hits and misses in a geotagging process. The value of 0.75 was selected for λ to create better fluctuations in scores of users (not all 1s, not all 0s, etc.). A majority of users, it is noted, have relatively low credibility scores.

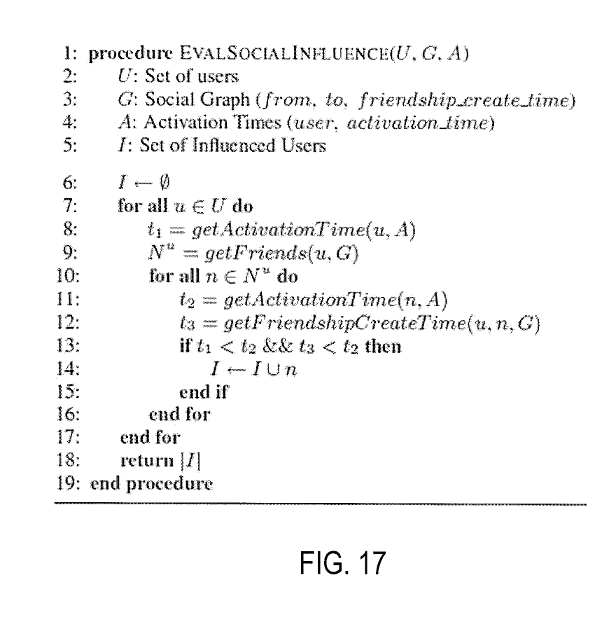

It may be possible to assess potential social influence of a user relative to a set of users of a network, such as a communication network, over a time period. An example process 1800 of FIG. 17 provides details of a recursive implementation for evaluating social influence in a finite number of operations. Process 1800 takes a set of users U, a graph G and the activation times of users A in the monitoring period [0,T], and returns the number of users that have potentially been influenced by the set of users U. Process 1800 is one example of a tool that may be used to assess and compare social influence of varying sets of users.

One may hypothesize that users who are more active are more influential. This may stand to reason because users who are more active upload more photos, and provide geotags for more photos. They may be considered “experts” of a sort, in a system of user-generated content. From a set of 25,000 users identified, two types of users were defined: more active users (at least 200 photos geotagged) and less active users (fewer than 20 photos geotagged). For activity level, a pair of sets may be formed comprising 1000 random users and compare their potential social influence using process 1800. Assuming increased visibility, such as through notification mechanisms made available by a communication network, active users, because they generate more content, are viewed by more people.

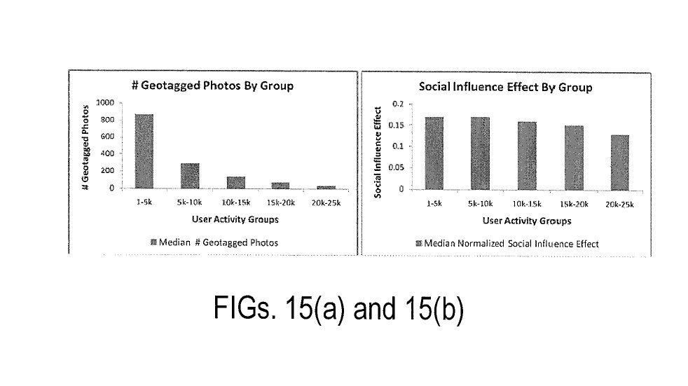

FIGS. 15(a) and 15(b) show that more active users are more influential, in terms of encouraging people to adopt geotagging. To establish this normality tests were run using the Shapiro-Wilk method, to show that the samples in each group do not follow a normal distribution. To compare the 5 different groups, a method that does not assume a normal population of samples, the Kruskal-Wallis test, was employed for a selected significance level alpha=0.05. This test is a non-parametric method for testing equality of population medians among groups. If the null hypothesis is rejected by the Kruskal-Wallis test, post-hoc analysis may be applied to identify which of the groups differ. Therefore, for the various cases, one may formally define the following hypotheses:

H0: The samples are not significantly different

Ha: The samples do not come from the same population

For the case of FIG. 15(b), the Kruskal-Wallis test showed that the samples do not come from the same population, thus rejecting the null hypothesis H0. Post-hoc analysis revealed that all groups were significantly different with each other. This supports the notion that more active users are more influential in the social network. In addition, an effect may be observed of increasing social influence as the number of users that have adopted a technology increases. Eventually the average number of neighbors that have adopted the technology also may also increase.

A measure of user credibility using distance from a target value was discussed previously: a user is more accurate as a geotagger if the user consistently places photos close to actual location. However, likewise, as previously discussed, user credibility may relate not only to how accurate a user is, but how accurate the user is perceived to be by other users. Thus, there may be an interplay between user influence and accuracy as represented by user credibility. More credible users may therefore be more influential.

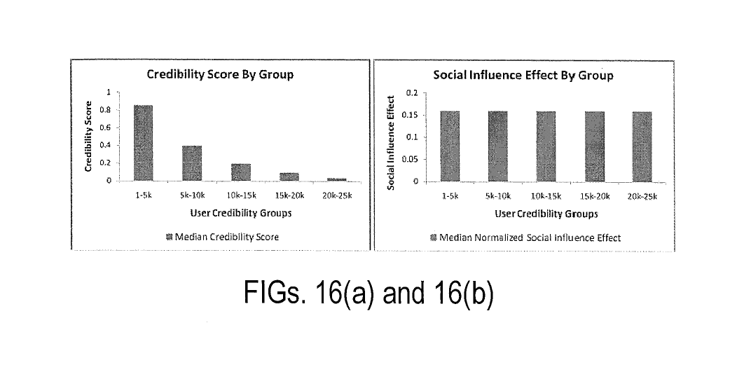

Sets of users may be defined for users that are more credible and users that are less credible. Potential social influence of these sets of users may be compared using process 1800, for example. To reduce or eliminate the effect of frequency with which users geotag photos, the defined sets may comprise users with similar geotagging activity as measured, for example, by geotagging frequency. Two subsets of users may be defined to compare a subset of 10% more credible users and a subset of 10% less credible users. One may expect, for example, that users with higher credibility scores—that is, users who are more accurate—may be more likely to be more influential. But as demonstrated by FIGS. 16(a) and 16(b), this may not always be the case. For the case of FIG. 16(b), the Kruskal-Wallis test showed that the samples come from the same population, thus accepting the null hypothesis H0. This supports the notion that being more credible does not necessarily make a user more influential in the social network. That is, a user may perform certain actions, such as geotagging, if that user sees another user do so, but whether or not the other user was accurate may not necessarily factor into a user's decision to also do so.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although claimed subject matter is not limited in scope in this respect, one embodiment may comprise one or more articles, such as a storage medium or storage media, for example, that may have stored thereon instructions executable by a specific or special purpose system or apparatus. As one potential example, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

In the preceding description, various aspects of claimed subject matter have been described. For purposes of explanation, systems or configurations were set forth to provide an understanding of claimed subject matter. However, claimed subject matter may be practiced without those specific details. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

What is claimed is:

1. A method, comprising:
computing via a special purpose computing system one or more user credibility signal sample values for a user based, at least in part, on one or more signal sample value deviations attributed to the user relative to other users regarding a characteristic of one or more electronic media or content items.

2. The method of claim 1, wherein the one or more deviations comprise a comparison of:
signal sample values for the characteristic associated by the user with one or more electronic media or content items; and
target signal sample values for the characteristic of the one or more electronic media or content items.

3. The method of claim 1, wherein the characteristic comprises a geographic location.

4. The method of claim 1, wherein the characteristic comprises a rating for a product represented by one or more electronic media or content items.

5. The method of claim 4, wherein the target signal sample value comprises a filtered combination of a plurality of other user ratings for the product.

6. The method of claim 5, wherein the filtered combination of the plurality of user ratings comprises a statistical mean of the plurality of other user ratings.

7. The method of claim 1, and further comprising:
updating the one or more user credibility signal sample values for the user.

8. A method comprising:
receiving a request for electronic media or content item from a user; and
transmitting electronic media or content item to the user based at least in part on user credibility signal sample values providing ratings with respect to the electronic media or content item available to be transmitted.

9. The method of claim 8, wherein the transmitting comprises transmitting electronic media or content item to the user based at least in part on user credibility signal sample values providing ratings with respect to a particular characteristic of the electronic media or content item available to be transmitted.

10. The method of claim 9, wherein the characteristic comprises a geographic location.

11. The method of claim 9, wherein the characteristic comprises a rating for a product represented by one or more electronic media or content items.

12. A method comprising:
determining via a special purpose computing system, for a set of users of an electronic social network in which activities of users in the set are at least partially visible to other users in the set, the users that have potentially been influenced by other users of the set, the determination being based at least in part on: a graph relating the set of users; and activation times for users in the set.

13. The method of claim 12, wherein the activation times for users in the set comprises activation times for the users to perform a particular operation via the electronic social network, the particular operation being visible to other users in the set.

14. The method of claim 13, wherein the particular operation comprises geotagging.

15. An apparatus comprising:
a special purpose computing system, said special purpose computing system having a capability to determine one or more user credibility signal sample values for a user based, at least in part, on one or more signal sample value deviations attributed to the user relative to other users regarding a characteristic of one or more electronic media or content items.

16. The apparatus of claim 15, wherein said special purpose computing system further having a capability to determine one or more user credibility signal sample values for a user based, at least in part, on one or more signal sample value deviations attributed to the user, the one or more signal sample values deviations comprising a comparison of:
signal sample values for the characteristic associated by the user with one or more electronic media or content items; and
target signal sample values for the characteristic of the one or more electronic media or content items.

17. The apparatus of claim 15, wherein said special purpose computing system further having a capability to determine one or more user credibility signal sample values for a user based, at least in part, on one or more signal sample value deviations attributed to the user relative to other users regarding a characteristic of one or more electronic media or content items, the characteristic comprising a geographic location.

18. The apparatus of claim 15, wherein said special purpose computing system further having a capability to determine one or more user credibility signal sample values for a user based, at least in part, on one or more signal sample value deviations attributed to the user relative to other users regarding a characteristic of one or more electronic media or content items, the characteristic comprising a rating for a product represented by one or more electronic media or content items.

19. An apparatus comprising:
a special purpose computing system, said special purpose computing system having a capability to receive a request for electronic media or content item from a user, and transmit electronic media or content item to the user based at least in part on user credibility signal sample values providing ratings with respect to the electronic media or content item available to be transmitted.

20. The apparatus of claim 19, wherein said special purpose computing system further having a capability to transmit comprises having a capability to transmit electronic media or content item to the user based at least in part on user credibility signal sample values providing ratings with respect to a particular characteristic of the electronic media or content item available to be transmitted.

21. The apparatus of claim 20, wherein said special purpose computing system further having a capability to transmit comprises having a capability to transmit electronic media or content item to the user based at least in part on user credibility signal sample values providing ratings with respect to a particular characteristic of the electronic media or content item available to be transmitted, the characteristic comprising a geographic location.

22. The apparatus of claim 20, wherein said special purpose computing system further having a capability to transmit comprises having a capability to transmit electronic media or content item to the user based at least in part on user credibility signal sample values providing ratings with respect to a particular characteristic of the electronic media or content item available to be transmitted, the characteristic comprising a rating for a product represented by one or more electronic media or content items.

23. An apparatus comprising:
a special purpose computing system, said special purpose computing system having a capability to determine, for a set of users of an electronic social network in which activities of users in the set are at least partially visible to other users in the set, the users that have potentially been influenced by other users of the set, the determination being based at least in part on: a graph relating the set of users; and
activation times for users in the set.

24. The apparatus of claim 23, wherein said special purpose computing system further having a capability to determine, for a set of users of an electronic social network, users of the set that have potentially been influenced by other users of the set based at least in part on: a graph relating the set of users; and activation times for users in the set, the activation times for users in the set comprising activation times for the users to perform a particular operation via the electronic social network, the particular operation being visible to other users in the set.

25. The apparatus of claim 24, wherein said special purpose computing system further having a capability to determine, for a set of users of an electronic social network, users of the set that have potentially been influenced by other users of the set based at least in part on: a graph relating the set of users; and activation times for users in the set, the activation times for users in the set comprising activation times for the users to perform a particular operation via the electronic social network, the particular operation comprising geotagging.

26. An article comprising: a storage media having stored thereon instructions executable by a special purpose computing system; said instructions being executable to determine one or more user credibility signal sample values for a user based, at least in part, on one or more signal sample value deviations attributed to the user relative to other users regarding a characteristic of one or more electronic media or content items.

27. The article of claim 26, wherein said instructions are further executable to determine one or more user credibility signal sample values for a user based, at least in part, on one or more signal sample value deviations attributed to the user, the one or more signal sample values deviations comprising a comparison of:
signal sample values for the characteristic associated by the user with one or more electronic media or content items; and
target signal sample values for the characteristic of the one or more electronic media or content items.

28. The article of claim 26, wherein said instructions are further executable to determine one or more user credibility signal sample values for a user based, at least in part, on one or more signal sample value deviations attributed to the user relative to other users regarding a characteristic of one or more electronic media or content items, the characteristic comprising a geographic location.

29. The article of claim 26, wherein said instructions are further executable to determine one or more user credibility signal sample values for a user based, at least in part, on one or more signal sample value deviations attributed to the user relative to other users regarding a characteristic of one or more electronic media or content items, the characteristic comprising a rating for a product represented by one or more electronic media or content items.

30. An article comprising: a storage media having stored thereon instructions executable by a special purpose computing system; said instructions being executable to receive a request for electronic media or content item from a user, and transmit electronic media or content item to the user based at least in part on user credibility signal sample values providing ratings with respect to the electronic media or content item available to be transmitted.

31. The article of claim 30, wherein said instructions are further executable to transmit electronic media or content item to the user based at least in part on user credibility signal sample values providing ratings with respect to a particular characteristic of the electronic media or content item available to be transmitted.

32. The article of claim 31, wherein said instructions are further executable to transmit electronic media or content item to the user based at least in part on user credibility signal sample values providing ratings with respect to a particular characteristic of the electronic media or content item available to be transmitted, the characteristic comprising a geographic location.

33. The article of claim 31, wherein said instructions are further executable to transmit electronic media or content item to the user based at least in part on user credibility signal sample values providing ratings with respect to a particular characteristic of the electronic media or content item available to be transmitted, the characteristic comprising a rating for a product represented by one or more electronic media or content items.

34. An article comprising: a storage media having stored thereon instructions executable by a special purpose computing system; said instructions being executable to determine, for a set of users of an electronic social network in which activities of users in the set are at least partially visible to other users in the set, the users that have potentially been influenced by other users of the set, the determination being based at least in part on: a graph relating the set of users; and activation times for users in the set.
